(19) United States
(12) Patent Application Publication
(10) Pub. No.: US 2024/0253336 A1
(43) Pub. Date: Aug. 1, 2024

(54) REUSABLE, WASHER AND DRYER SAFE MAT DEVICE

(71) Applicant: Shoaib Khadri, Naperville, IL (US)

(72) Inventor: Shoaib Khadri, Naperville, IL (US)

(21) Appl. No.: 18/498,976

(22) Filed: Oct. 31, 2023

Related U.S. Application Data
(60) Provisional application No. 63/424,509, filed on Nov. 11, 2022.

(51) Int. Cl. B32B 27/12; B32B 5/06; B32B 5/26; B32B 7/02; B32B 7/12; B32B 27/36; B32B 37/06; B32B 37/12; B32B 37/14

(52) U.S. Cl. CPC B32B 27/12; B32B 5/073; B32B 5/26; B32B 7/02; B32B 7/12; B32B 27/36; B32B 37/06; B32B 37/12; B32B 37/144; B32B 2250/03; B32B 2255/10; B32B 2262/04; B32B 2262/062; B32B 2307/7145; B32B 2307/7265; B32B 2307/746; B32B 2605/00

(57) ABSTRACT

This invention is a multilayered arrangement with each layer attached to each other by different means of attachments that include, but not limited to quilting, fusing, etc. The invention is used as a protection of any surface from leaks, stains, damage, spills, bacteria or discharge of any type. The invention is designed to withstand washes in the conventional washer and dryer whether it is for a home, commercial or industrial use. It is reusable after numerous washes since it retains the original quality without degradation. The invention is designed to make it absorbent, leak-proof, safe for the washer and dryer, and skid proof so it does not slide on surfaces it is used on. The invention has variable dimensions including custom cut that is tailored to the structure of any surface that it is being used on based on the application. The device can be used on various applications that includes, but not limited to, sleeping surface, outdoor picnic, beach, floor, pets, automobiles, bathroom, kitchen, babies and surfaces subject to damage by leaks.

### FIELD OF THE INVENTION

The present invention relates to an absorbent, leak-proof, skid-resistant, multi-layered arrangement which is safe for washer and dryer at high temperatures used to protect a surface from leaks, stains or discharge of any type with a multitude of applications including but not limited to, sleeping surface, outdoor picnic, beach, floor, pets, automobiles, bathroom, kitchen, babies and surfaces subject to damage by leaks.

### BACKGROUND INFORMATION

The present invention has certain similarities to other existing patents and/or publications as detailed below. However, the major disadvantages of the prior art inventions are not designed to withstand high temperatures in the washing machines that include conventional washer and dryer in the homes, commercial or industrial settings without damaging the fabric. Moreover, the fabrics of the prior art are not designed for adhering to different surfaces without slipping, skidding or sliding. The present invention of this application has many unique features and functionalities overcome the limitations of the prior art that make it uniquely distinguishable

This section lists the prior art patents with a short summary of each patent to showcase that these prior patents are similar but lack the unique features of the present invention
a) Patent #: U.S. Pat. No. 7,886,378B2—This patent disclosed a soft leak-proof protective blanket with three layers for covering e.g. beds, car seats with the first layer that allows liquid to pass through, second layer that catches some of the liquid and third layer that catches liquid passing through second layer
b) Patent #: U.S. Pat. No. 8,318,285B1—This patent disclosed an article for absorbing fluids that includes a backing sheet and an absorption sheet, wherein the absorption sheet is made of a material that is capable of absorbing any oil based liquid, and wherein the backing sheet is at least partly affixed to the absorption sheet; at least one first fastener means, wherein the first fastener means includes an attachment means on the bottom side and a mating attachment means on the top side, and wherein the bottom side of the first fastener means is at least partly affixed to a top side of the absorption sheet; and one or more malleable strips positioned along at least a portion of a length of the article.
c) Patent #: U.S. Pat. No. 6,274,520B1—This patent disclosed a waterproof fabric sheet for a baby crib, a bassinet, a bed for a health care facility or the like. The fabric sheet is a five-layer laminated waterproof cloth, light in weight, absorbent, breathable, optionally antimicrobial, and washable. The first top layer comprises a material made from polyester fibers and/or cotton fibers. The second layer is a needle punch soaker or a high loft batting soaker made from rayon fibers, polyester fibers and/or cotton fibers being needle punched into a nonwoven polyester or polypropylene scrim material or high loft batting. The third layer comprises a sheet material of polyester and/or acrylic. The fourth layer can be either identical to the second layer or without soaker properties. The fifth layer comprises either polyester, nylon or acrylic material. The second and/or the fourth layers optionally include antimicrobial fibers. The layers are laminated by ultrasonic energy bonding. If the first layer contains greater than 40% cotton fibers, the layer is bonded to the second layer with a water-based urethane glue.
d) Patent #: U.S. Pat. No. 4,772,281A—This patent disclosed an absorbent re-usable patient underpad is formed of five layers of fabric consisting from top to bottom of: an absorbent rayon-polyester blend, non-woven polyester; vinyl; and polyester, a synthetic taffeta. The third, fourth and fifth layers are bonded together as are, generally, the first and second layers.
e) Patent #: WO2004034844A3—This patent disclosed a laminated waterproof bedding article is formed from a first layer of woven fabric, a second layer of woven or non-woven water-absorbent material that includes thermoplastic filaments, a third layer of a waterproof web of thermoplastic polymeric material, and an optional fourth layer of woven or non-woven fabric that includes thermoplastic filaments, the webs being joined along a plurality of spaced-apart seams to form a unitary structure: optional stitching, which can be decorative, intersects the heat-bonded seams.
f) Publication #: US20210402372A1—This publication disclosed a washable multi-layer composite capable of fluid containment that may be used to protect a surface from liquid infiltration.

### SUMMARY OF THE INVENTION

This present invention overcomes the deficiencies of prior art inventions with its uniquely distinguishing features and improvements as detailed below

This present invention is safe for all types of conventional washers and dryers, including those with home, commercial or industrial use. It is designed to withstand high temperatures in the washing cycles and drying cycles.

This present invention includes a layer designed for skid resistance for stability and avoid sliding and skidding on any surfaces that it is used on.

This present invention includes custom-cut patterns with variable dimensions and orientation to conform to surfaces that it is used on.

### DETAILED DESCRIPTION OF THE DRAWINGS

The accompanying set of drawings illustrate the embodiment of the present invention, combined with the description below, serve to clearly explain the technical principles, construction, functionality, and arrangement of the invention.

FIG. 1 is the top view of one embodiment of the invention which serves as a reusable mat that can be used for a variety of applications. This figure shows a standard size. FIG. 1a shows the top layer surface with a facing fabric of the device which makes is soft and absorbent. FIG. 1b shows the second layer that has the capability for wicking where any liquid can dissipate without puddling on the surface. FIG. 1c is the third layer that has the barrier property that makes it leak-proof by preventing flow of liquids. FIG. 1d is the bottom layer that is designed per the surface that is used on.

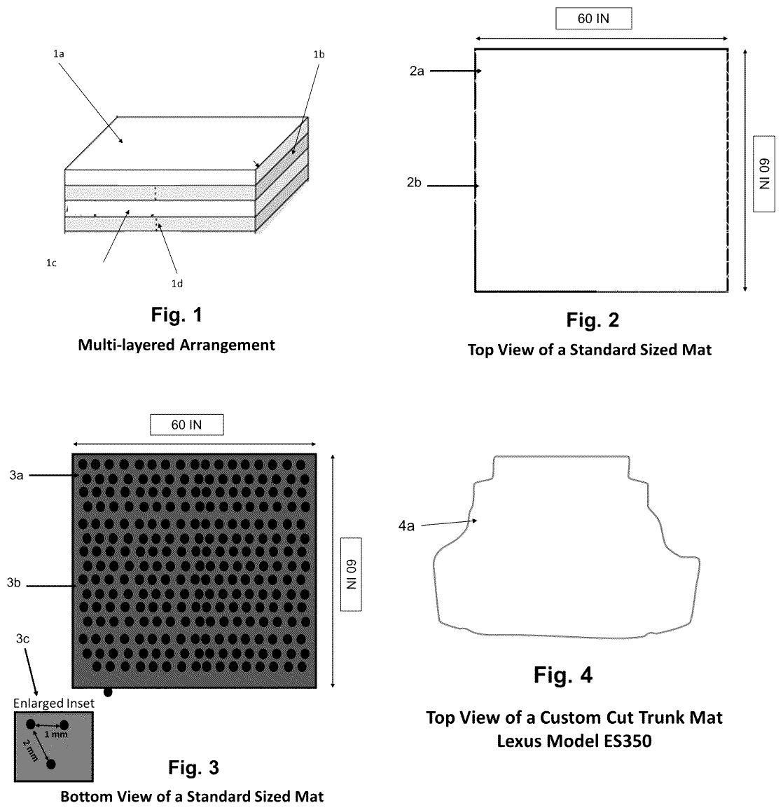

FIG. 2 shows the top view of a standard sized mat which is square in shape has a length of 60 inches and a width of 60 inches. However, the size and shape of the mats can vary depending on the application. FIG. 2a shows the facing fabric of the device that is made from a blend of Thermoplastic polyurethane (TPU) polyester of 70% to 100% of the blend and rayon of 1% to 30%. The blend can be a combination of other fibers like cotton, bamboo, etc. and other natural and man-made fibers to make sure that it has the feature of being absorbent and soft. FIG. 2b points to the stitching on the entire device that holds multiple layers in place in a quilt stitch. The variable stitching pattern can be a straight diamond, a curved diamond or a wave pattern.

FIG. 3 shows the bottom view of the mat device which is designed to perform different functions based on the application it is used on. FIG. 3a shows the material of the bottom layer which varies based on how the device would cling to the surface it is used on. For example, when it is used on the bed, it has a polyester backing that makes sure it does not slide on the mattress and when it is used as a trunk mat, it has a silicone backing to ensure skid resistance even when heavy items are placed and removed from the trunk. FIG. 3b shows silicone dots that are embedded in the bottom silicone layer during the manufacturing process in a particular pattern that are spaced in the correct configuration —between 1 millimeter to 3 millimeter interspaced between the dots, providing grip to the entire device so it does not slide or skid on the surface it is used on. FIG. 3c shows an enlarged embodiment of the dots to explain the particular pattern with dimensions that is applied to the configuration of the interspacing between the dots.

FIG. 4 shows the top view of a custom cut trunk mat of a vehicle designed to the exact size and shape of a 2019 Lexus Model ES350. This is an example of a custom cut trunk mat that is laser cut to the exact dimensions of any vehicle based on Make, Model and Year of the vehicle.

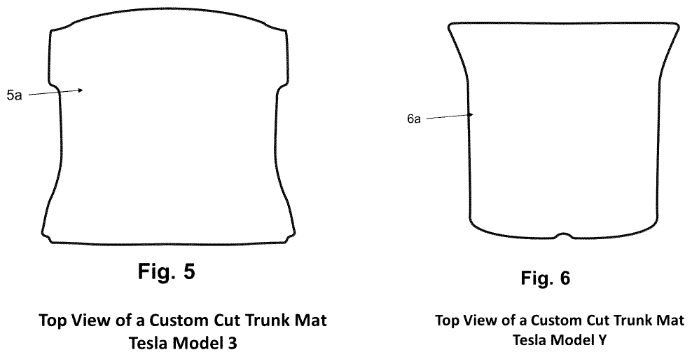

FIG. 5 shows the top view of a custom cut trunk mat of a vehicle designed to the exact size and shape of a 2022 Tesla Model 3. This is an example of a custom cut trunk mat that is laser cut to the exact dimensions of any vehicle based on Make, Model and Year of the vehicle.

FIG. 6 shows the top view of a custom cut trunk mat of a vehicle designed to the exact size and shape of a 2022 Tesla Model Y. This is an example of a custom cut trunk mat that is laser cut to the exact dimensions of any vehicle based on Make, Model and Year of the vehicle.

1. A reusable mat device configured in custom cut shapes and sizes as a machine washable dryable mat of multilayered arrangement comprising:
a. a facing first layer surface fabric wherein the first layer is made from a soft, absorbent fabric;
b. a wicking second layer wherein the second layer instantly dissipates any liquid by making the facing fabric dry quickly;
c. a protective barrier third layer wherein the third layer is preventing liquid from seeping through the device thereby protecting a surface that it is used on;
d. a bottom fourth layer wherein the bottom layer has a fabric that is designed to cling to a surface that it is used on, without shifting with a unique silicone coating and a particularly arranged dots protruding from the silicone layer.

2. The reusable mat device of claim 1 wherein it is made from a combination blend of a natural fiber and a man-made fiber providing absorbent property of the mat device.

3. The said natural fiber of claim 2 wherein the natural fiber is bamboo fiber for providing comfort and softness.

4. The said natural fiber of claim 2 wherein the natural fiber is cotton fiber for providing comfort and softness.

5. The said natural fiber of claim 2 wherein the natural fiber is rayon fiber for providing comfort and softness.

6. The said man-made fiber of claim 2 wherein the fiber is a polyester for providing strength and stability.

7. The reusable mat device of claim 1 wherein the layers are adhered to each other by means of an adhesive and bounded together by a quilt pattern formation stitching across all layers.

8. The reusable mat device of claim 1 wherein the bottom layer is made of 100% polyester with a silicone backing designed for slip resistance on a surface that is used upon.

9. The reusable mat device with the silicone backing of claim 8 wherein the silicone backing has silicone dots embedded in the layer during the manufacturing process wherein the interspacing between the dots are configured in a particular pattern.

10. The reusable mat device of claim 1 wherein the bottom layer is made of 100% polyester without any silicone backing designed for slip resistance on a different surface that is used upon.

11. The said reusable mat of claim 1 is configured for different sizes wherein a standard multipurpose mat has dimensions of 60 inches by 60 inches and a smaller version of this mat has dimensions of 36 inches by 60 inches or a baby mat version of 30 inches by 36 inches.

12. The said reusable mat of claim 1 is custom cut with different shapes and sizes configured to the application it is used on.

13. The said custom cut mat of claim 12 is configured to the exact shape and size of the trunk of a vehicle based on Make, Model and Year of the vehicle.

14. The said custom cut mat of claim 12 is configured to the shape and size specific to each application like a dish drying mat in kitchen with a size of the kitchen counter top, or a circular mat for indoor plants with a size of the circumference of the bottom of the pot that the plant is placed in.

15. A method for fabricating a custom cut exercise mat configured as a reusable mat of multilayered arrangement comprising:
a. Integrating three layers of fabric by applying heat and adhesive wherein a facing first layer soft fabric is an absorbent surface allowing sweat to be absorbed and preventing liquid stagnation, a wicking second layer wherein the second layer instantly dissipates any liquid by making the facing fabric dry quickly and a protective barrier third layer wherein the third layer is preventing liquid from seeping through thereby protecting a surface that it is used on; and a fourth bottom layer that is designed for skid resistance on the surface it is used on.
b. Attaching all the integrated layers in a manner of quilt stitching using different patterns for the stitching including diamond weave or wave pattern.
c. Coating a bottom anti-skid layer with silicone wherein the bottom layer has a special anti-skid coating preventing skidding on a surface that it is used on.
d. Applying dots on the silicone layer particularly arranged in an interspacing configuration of specific dimensions.

16. The said method of claim 15 wherein applying felt dots to the facing fabric surface as a variation method wherein the dots are protruding slightly from the surface providing a firm grip for a user.

17. The said method of claim 15 wherein cutting the multilayered arrangement in a desired shape and dimension for specific applications.
